(19) United States
(12) Patent Application Publication
(10) Pub. No.: US 2007/0291704 A1
(43) Pub. Date: Dec. 20, 2007

(54) Internet protocol address take-over system in a local area network and method thereof

(75) Inventors: Jian-Feng Guo, Tianjin (CN); Xing-Jia Wang, Tianjin (CN); Cang-Mou Cao, Tianjin (CN); Yi Chen, Tianjin (CN); Tom Chen, Taipei (TW); Win-Harn Liu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/452,258

(22) Filed: Jun. 14, 2006

(51) Int. Cl. H04Q 7/24

(52) U.S. Cl. 370/338

(57) ABSTRACT

An Internet protocol (IP) address take-over system in a local area network and a method thereof are provided. The IP address take-over system takes over the IP addresses in a server connecting with a plurality of clients and containing a plurality of network interface cards, and automatically updates the media access control (MAC) addresses stored in the address resolution protocol (ARP) caches of the clients and corresponding to the IP address of the server, so as to guarantee the continuity of the network communication between the clients and the server, and improve the reliability of the server.

### BACKGROUND OF THE INVENTION

1. Field of Invention

The present invention relates to an Internet protocol (IP) address management system and a method thereof, and more particularly to an IP address take-over system in a local area network (LAN) and a method thereof.

2. Related Art

An Internet Protocol (IP) address is a 32-bit binary numeral for identifying the address of every computer in the Transmission Control Protocol/Internet Protocol (TCP/IP). The network facility manufacturer writes a unique media access control (MAC) address of 48 bits in the hardware of a network interface card (NIC) during its production. When a NIC is used, not only the MAC address in the NIC but also an address designated by a user can be adopted, however the latter one must be unique. In a computer network, the communication among the computers finally appears as that a data packet is sent from an original node, then sent from one node to another, and finally to a destination node. The movement of the data packet among the nodes is completed by mapping the IP address to the MAC address by the Address Resolution Protocol (ARP). The ARP maps the IP address to the MAC address in a manner by which a correspondence list of the IP address and the MAC address stored in the ARP cache of the computer is looked up first. When the correspondence list does not exist, an ARP requirement is broadcasted, and an ARP reply is unicasted to the local node from a node with a destination IP address, then the local node adds this term into the ARP cache, thus the IP address mapping is completed. The IP address of the node communicating with the present computer and the corresponding MAC address thereof are stored in the ARP cache, and the contents stored therein will expire after a certain time period.

At present, servers providing network service are usually provided with a plurality of NICs. Not only is the data transmission rate of the server effectively improved by the NICs, but when an NIC malfunctions, the IP address thereof can be taken over by another NIC which is operating normally in the same or a different network segment, therefore the reliability of the server is significantly enhanced. Moreover, the conventional IP address take-over system broadcasts the address resolution reply to update the MAC address stored in the ARP cache of the client connected with the server and corresponding to the IP address.

However, there are still lots of defects in the conventional technology. Particularly, when it comes to some host systems and exchangers for preventing the ARP from being cheated and attacked, the single address resolution reply tends to be discarded. After the IP address is taken over by a NIC which operates normally, the MAC address stored in the ARP cache of a client connected with the server and corresponding to the IP address has not been updated in time, thus the client cannot connect to the NIC which operates normally, thereby resulting in the disconnection of the client and the server. At the same time, the network burden of the switch LAN is increased enormously by broadcasting the address resolution reply.

### SUMMARY OF THE INVENTION

In order to solve the problems and defects in the conventional technology, one of the objects of the present invention is to provide an IP address take-over system in a local area network for taking over the IP addresses in a server connecting with a plurality of clients and containing a plurality of NICs. The system comprises a central processing unit (CPU); a network connection state detection module, which is used for detecting the network connection state of a NIC of the server and sending a state signal to the CPU; an IP address take-over module, which is used for receiving a control signal sent by the CPU, clearing the setting of the disconnected NIC according to the control signal, and setting the IP address of the NIC to be a slave IP address of another NIC which operates normally in the same or a different network segment; and a unicast ARP requirement send module, which is used for receiving a control signal sent by the CPU, and unicasting an ARP requirement including the MAC of another NIC to the plurality of clients according to the control signal.

Wherein, the server includes a CPU, a network connection state detection module, an IP address take-over module, a unicast ARP requirement send module, and a plurality of NICs.

Another object of the present invention is to provide an IP address take-over method in a local area network for taking over the IP addresses in a server connecting with a plurality of clients and containing a plurality of NICs. The method comprises recording the IP addresses of the plurality of clients connected with a NIC of the server and a MAC address of each client; detecting a network connection state of the NIC; and when the network of the NIC is disconnected, clearing the setting of the NIC and setting the IP address of the NIC to be a slave IP address of another NIC which operates normally in the same or a different network segment; and unicasting an ARP requirement including the IP address of the NIC, a MAC address of another NIC, the IP address of each client, and the MAC address of each client to each client, so as to update the MAC address stored in an ARP cache of each client and corresponding to the IP address of the NIC.

The step of setting the IP address of the NIC to be the slave IP address of another NIC which operates normally in the same or a different network segment further comprises: when the IP address of the NIC and the IP address of another NIC are in the same network segment, using a route of the network segment; when the IP address of the NIC and the IP address of another NIC are in different network segments and there is no route there-between, using a route of a master IP address of the other NIC; and when the IP address of the NIC and the IP address of another NIC are in different network segments and there are routes there-between, using a route without the IP addresses of the routes connecting the two network segments.

To sum up, the advantage of the present invention lies in that when a client and a NIC of the server are disconnected, another NIC which operates normally in the server can take over the IP address of the disconnected NIC securely, and can automatically update the MAC address stored in the ARP cache of the client and corresponding to the address of the disconnected NIC by unicasting. The above actions are all completed in the server with the execution time thereof being on the order of milliseconds, thus clients will not feel the disconnection of the server network. Therefore the continuity of the network communication between the clients and the server is guaranteed, and the reliability of the server is improved.

### BRIEF DESCRIPTION OF THE DRAWINGS

FIG. 1 is a block diagram of the system of the present invention; and

FIG. 2 is a flow chart of the method of the present invention.

### DETAILED DESCRIPTION OF THE INVENTION

The preferred embodiment of the present invention will be described in detail with accompany drawings as below.

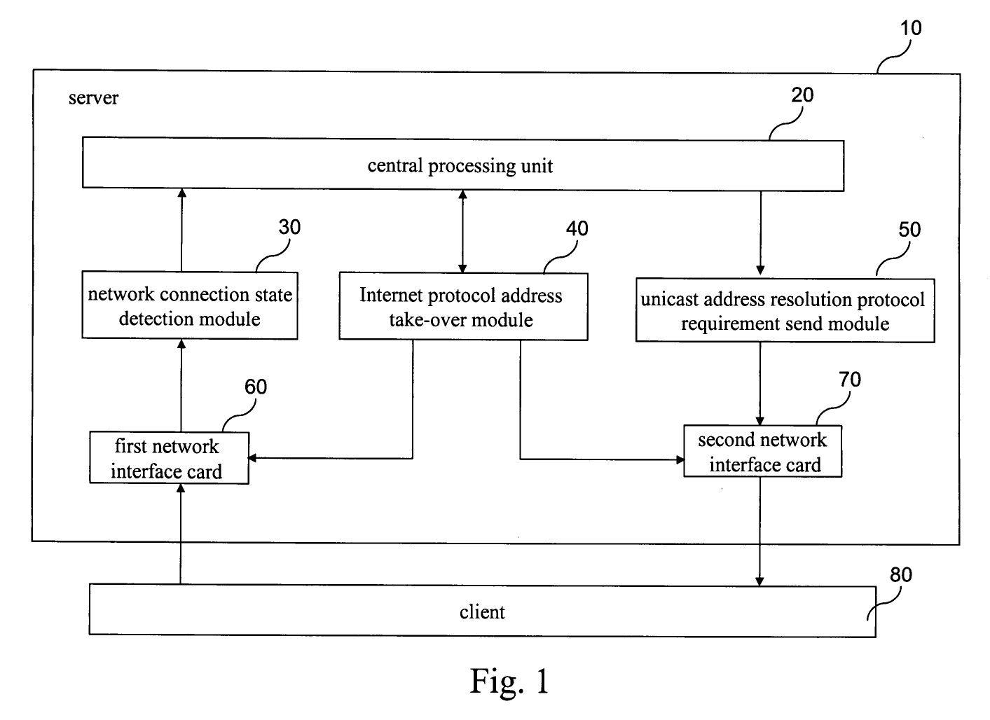

Referring to FIG. 1, it shows an IP address take-over system in a local area network of the present invention, which is used for taking over the IP addresses in a server 10 connecting with a plurality of clients 80 and containing a plurality of NICs. The system comprises a CPU 20, a network connection state detection module 30, an IP address take-over module 40, a unicast ARP requirement send module 50, a first NIC 60, and a second NIC 70.

The server 10 includes a CPU 20, a network connection state detection module 30, an IP address take-over module 40, a unicast ARP requirement send module 50, a first NIC 60, and a second NIC 70. The network connection state detection module 30 disposed between the CPU 20 and the first NIC 60 is used for detecting the network connection state of the first NIC 60 by receiving the signals sent by the first NIC 60, and sending a disconnection signal to the CPU 20 when the first NIC 60 is disconnected. The IP address take-over module 40, connected respectively with the CPU 20, the first NIC 60, and the second NIC 70, is used for receiving a control signal sent by the CPU 20, clearing the setting of the first NIC 60 according to the control signal, and setting the IP address of the first NIC 60 to be a slave IP address of a second NIC 70 which operates normally in the same or a different network segment. The unicast ARP requirement send module 50 disposed between the CPU 20 and the second NIC 70 is used for receiving the control signal sent by the CPU 20, and forcibly unicasting an ARP requirement containing the MAC address of the second NIC 70 to each client 80 through the second NIC 70 according to the control signal, so as to update the MAC address stored in an ARP cache of each client 80 and corresponding to the IP address of the first NIC 60.

The embodiment of the present invention will be described in more detail below.

The client 80 is connected with the first NIC 60 of the server 10 through an IP address, and the IP address of the server 10 and the MAC address of the first NIC 60 are stored in a correspondence list of the IP address and the MAC address stored in the local ARP cache. Meanwhile, the server 10 records the IP address and the MAC address of the client 80 connected with the first NIC 60. The network connection state detection module 30 receives the signals sent by the first NIC 60 continuously, so as to determine the network connection state of the first NIC 60. When the first NIC 60 is disconnected, the network connection state detection module 30 sends a disconnection signal to the CPU 20. The CPU 20 sends a control signal to the IP address take-over module 40 after receiving the disconnection signal. The IP address take-over module 40 clears the setting of the first NIC 60, and sets the IP address of the first NIC 60 to be a slave IP address of the second NIC 70 which operates normally in the same or a different network segment, according to the control signal. When the IP address of the first NIC 60 and the IP address of the second NIC 70 are in the same network segment, a route of the network segment is used; when the IP address of the first NIC 60 and the IP address of the second NIC 70 are in different network segments and there is no route there-between, a route of a master IP address of the second NIC 70 is used; when the IP address of the first NIC 60 and the IP address of the second NIC 70 are in different network segments and there are routes there-between, a route without the IP addresses of the routes connecting the two network segments is used. After a successful setting, the IP address take-over module 40 sends a successful setting signal to the CPU 20. The CPU 20 sends a control signal to the unicast ARP requirement send module 50 after receiving the successful setting signal. The unicast ARP requirement send module 50 traverses the IP address and the MAC address of the client 80 connected with the first NIC 60, which are recorded by the server 10, according to the control signal, and forcibly unicasts an ARP requirement including the IP address of the first NIC 60, the MAC address of the second NIC 70 set with the IP address, the IP address and the MAC address of the client 80 to the IP address of the client 80, so as to update the MAC address stored in the ARP cache of the client 80 and corresponding to the IP address of the first NIC 60.

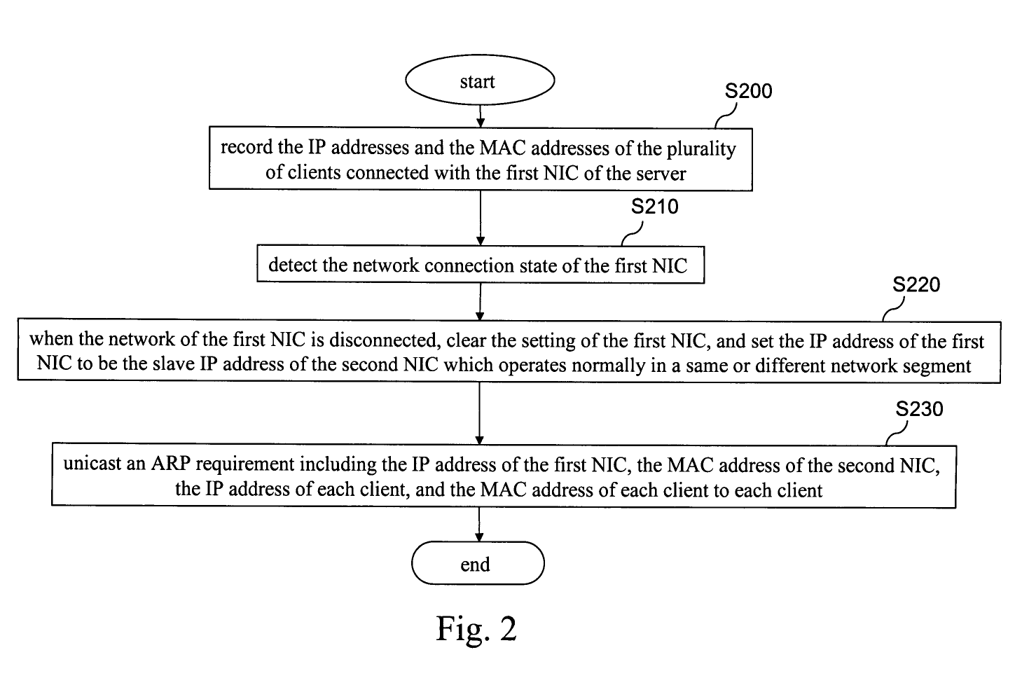

Now referring to FIG. 2, it is a flowchart of the method of the present invention. As shown in the drawing, the method of the present invention comprises recording the IP address and the MAC address of the client 80 connected with the first NIC 60 of the server 10 (step S200); detecting the network connection state of the first NIC 60 (step S210); when the network of the first NIC 60 is disconnected, clearing the setting of the first NIC 60, and setting the IP address of the first NIC 60 to be the slave IP address of the second NIC 70 which operates normally in the same or a different network segment (step S220); and unicasting an ARP requirement including the IP address of the first NIC 60, the MAC address of the second NIC 70, the IP address of the client 80, and the MAC address of the client 80 to the client 80 (step S230).

First, the client 80 is connected with the first NIC 60 of the server 10 through an IP address, and the IP address of the server 10 and the MAC address of the first NIC 60 are stored in a correspondence list of the IP address and the MAC address stored in the local ARP cache. Meanwhile, the server 10 records the IP address and the MAC address of the client 80 connected with the first NIC 60 through the IP address (step S200). Then, the network connection state detection module 30 receives the signals sent by the first NIC 60 continuously so as to determine the network connection state of the first NIC 60 (step S210). When the first NIC 60 is disconnected, the network connection state detection module 30 sends a disconnection signal to the CPU 20. The CPU 20 sends a control signal to the IP address take-over module 40 after receiving the disconnection signal. The IP address take-over module 40 clears the setting of the first NIC 60, and sets the IP address of the first NIC 60 to be a slave IP address of the second NIC 70 which operates normally in the same or a different network segment, according to the control signal (step S220). At this time, when the IP address of the first NIC 60 and the IP address of the second NIC 70 are in the same network segment, a route of the network segment is used; when the IP address of the first NIC 60 and the IP address of the second NIC 70 are in different network segments and there is no route there-between, a route of a master IP address of the second NIC 70 is used; when the IP address of the first NIC 60 and the IP address of the second NIC 70 are in different network segments and there are routes there-between, a route without the IP addresses of the routes connecting the two network segments is used. After a successful setting, the IP address take-over module 40 sends a successful setting signal to the CPU 20. The CPU 20 sends a control signal to the unicast ARP requirement send module 50 after receiving the successful setting signal. The unicast ARP requirement send module 50 traverses the IP address and the MAC address of the client 80 connected with first NIC 60, which are recorded by the server 10, according to the control signal, and forcibly unicasts an ARP requirement to the IP address of the client 80 (step S230). The ARP requirement includes the IP address of the first NIC 60, the MAC address of the second NIC 70, the IP address and the MAC address of the client 80, so as to update the MAC address stored in the ARP cache of the client 80 and corresponding to the IP address of the first NIC 60.

What is claimed is:

1. An Internet protocol (IP) address take-over system in a local area network, for taking over the IP addresses in a server connecting with a plurality of clients and containing a plurality of network interface cards (NIC), the system comprises:
a central processing unit (CPU);
a network connection state detection module for detecting the network connection state of a first NIC of the server and sending a state signal to the CPU;
an IP address take-over module for receiving a control signal sent by the CPU, clearing the setting of the first NIC according to the control signal, and setting the IP address of the first NIC to be a slave IP address of a second NIC which operates normally in the same or a different network segment; and
a unicast address resolution protocol (ARP) requirement send module for receiving a control signal sent by the CPU and unicasting an ARP requirement including the IP address of the first NIC, a media access control (MAC) address of the second NIC, the IP address of each of the clients, and the MAC address of each of the clients to each of the clients, according to the control signal.

2. The IP address take-over system in a local area network as claimed in claim 1, wherein the network connection state detection module is used for detecting the network connection state of the first NIC by receiving the signals sent by the first NIC continuously.

3. The IP address take-over system in a local area network as claimed in claim 1, wherein when the IP address take-over module clears the setting of the first NIC, and sets the IP address of the first NIC to be the slave IP address of the second NIC which operates normally in the same or a different network segment, further comprising:
when the IP address of the first NIC and the IP address of the second NIC are in the same network segment, using a route of the network segment;
when the IP address of the first NIC and the IP address of the second NIC are in different network segments and there is no route there-between, using a route of a master IP address of the second NIC; and
when the IP address of the first NIC and the IP address of the second NIC are in different network segments and there are routes between each other, using a route without the IP addresses of the routes connecting the two network segments.

4. An IP address take-over method in a local area network for taking over the IP addresses in a server connecting a plurality of clients and containing a plurality of NICs, the method comprises the following steps:
recording the IP addresses of the plurality of clients connected with a first NIC of the server and a MAC address of each of the clients;
detecting a network connection state of the first NIC;
when the network of the first NIC is disconnected, clearing the setting of the first NIC, and setting the IP address of the first NIC to be a slave IP address of a second NIC which operates normally in the same or a different network segment; and
unicasting an ARP requirement including the IP address of the first NIC, a MAC address of the second NIC, the IP address of each of the clients, and the MAC address of each of the clients to each of the clients, so as to update the MAC address stored in an ARP cache of each of the clients, wherein the MAC address corresponds to the IP address of the first NIC.

5. The IP address take-over method in a local area network as claimed in claim 4, wherein the detection of the network connection state of the first NIC is completed by detecting the signals sent by the first NIC.

6. The IP address take-over method in a local area network as claimed in claim 4, wherein when the network of the first NIC is disconnected, clearing clear the setting of the first NIC and setting the IP address of the first NIC to be the slave IP address of a second NIC which operates normally in the same or a different network segment further comprising:
when the IP address of the first NIC and the IP address of the second NIC are in the same network segment, using a route of the network segment;
when the IP address of the first NIC and the IP address of the second NIC are in different network segments and there is no route there-between, using a route of a master IP address of the second NIC; and
when the IP address of the first NIC and the IP address of the second NIC are in different network segments and there are routes there-between, using a route without the IP addresses of the routes connecting the two network segments.
